(19) United States
(12) Patent Application Publication
(10) Pub. No.: US 2008/0018137 A1
(43) Pub. Date: Jan. 24, 2008

(54) Assembly comprising a headlamp block support and a motor vehicle fender, and a support forming part of such an assembly

(75) Inventor: Jean Troton, Munich (DE)

Correspondence Address: OLIFF & BERRIDGE, PLC, P.O. BOX 320850, ALEXANDRIA, VA, 22320-4850, US

(73) Assignee: COMPAGNIE PLASTIC OMNIUM, LYON (FR)

(21) Appl. No.: 11/808,093

(22) Filed: Jun. 6, 2007

(30) Foreign Application Priority Data
Jun. 8, 2006 (FR) 0652067

(51) Int. Cl. B60R 19/02

(52) U.S. Cl. 296/198

(57) ABSTRACT

The present invention relates to an assembly comprising a headlamp block support and a motor vehicle fender, the fender having an inside face, an outside face, and a proximal edge for being placed adjacent to a glass of the headlamp block, the support being designed to be secured to a bottom side rail and to a top side rail of the vehicle. The support has a bonding outer surface for bonding to a portion of the inside face of the fender, situated in the vicinity of the proximal edge of the fender, said bonding outer surface extending along the proximal edge of the fender.

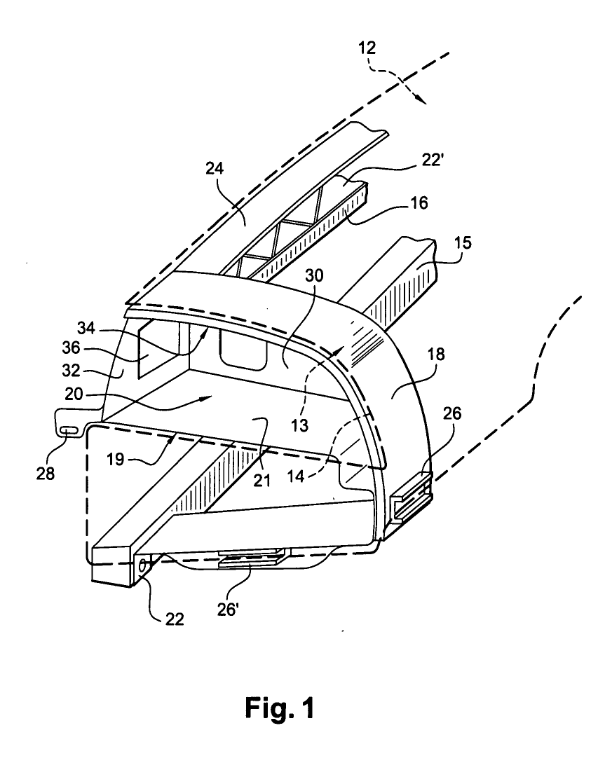

The present invention relates to an assembly comprising a headlamp block support and a motor vehicle fender, and also relates to a support forming part of such an assembly.

Document EP 0 839 704 B1 discloses a side support for putting into place at the front of a motor vehicle, around an engine compartment, and for supporting bodywork elements made of plastics material, such as a fender and a bumper skin, as well as functional elements of the vehicle, such as a headlamp block and a battery. The support is designed to be secured to a bottom side rail and to an associated top side rail of the vehicle body.

Such a support includes a box surrounding a housing for receiving a headlamp block. The support also includes means for connection with the fender, of a kind that is not described in detail in that document.

Thus, the headlamp block and the fender are positioned relative to a single part, thus making it easy to manage the gaps and the flush portions between the fender and the headlamp block, while assembling the vehicle.

Furthermore, it is known that a vehicle fender made of plastics material tends to expand as a result of variations in outside temperature, and that this expansion gives rise to relative displacements between the fender and adjacent parts, in particular in the front region of the vehicle, in register with the headlamp block.

The support described in EP 0 839 704 B1 can easily accommodate such expansions, since being made of plastics material like the fender and having the same size as the fender, that support expands in a manner equivalent to said fender.

Nevertheless, when for reasons of appearance, the headlamp block needs to be held securely relative to the main structure of the vehicle, and as a result can not follow the movements of the fender towards the front of the vehicle, the gaps and the flush portions between the fender and the headlamp block are no longer guaranteed, which can spoil the appearance of the front of the vehicle.

The present invention seeks to remedy that drawback.

To this end, the invention provides an assembly comprising a headlamp block support and a motor vehicle fender, the fender having an inside face, an outside face, and a proximal edge for being placed adjacent to a glass of the headlamp block, the support being designed to be secured to a bottom side rail and to a top side rail of the vehicle, the assembly being characterized in that the support has a bonding outer surface for bonding to a portion of the inside face of the fender situated in the vicinity of the proximal edge of the fender, said bonding outer surface extending along the proximal edge of the fender.

Thanks to the invention, the bonding outer surface of the support provides continuous bonding between the support and the proximal edge of the fender and prevents any movement of the proximal edge of the fender relative to the headlamp block.

The proximal edge of the fender, bonded in this way to the support, is thus no longer in a position to alter the gaps and the flush portions initially set between the headlamp block and the fender, even on being subjected to a high degree of expansion.

Expansion of the fender can thus no longer give rise to the proximal edge of the fender moving forwards. Thanks to the invention, the central portion of the fender can be left free, since the support is secured to the fender only via its bonding outer surface which is located close to the proximal edge of the fender. The fender is thus free to deform a little in a direction that is transverse relative to the vehicle, thereby “bulging” outwards from the vehicle, with such deformation not leading to any deterioration in the function or in the visible appearance of the vehicle.

In addition, the support and fender assembly constitutes a fender module that includes the headlamp block. The module can be fabricated away from the main assembly line. The invention thus enables savings to be achieved in manufacturing costs.

Advantageously, the support includes a box that defines a housing for receiving the headlamp block, an outer surface of the box including the bonding outer surface.

In this way, the bonding outer surface is placed as close as possible to the headlamp block, and control over the gaps and the flush portions between those two elements of the motor vehicle is facilitated from the moment they are assembled together. The appearance of the front of the motor vehicle is thus guaranteed.

Advantageously, the support includes fastener means for fastening at least one of the elements in the following list:
cooling means;
a central grille;
an air guide; and
an electric cable.

The support is thus designed so that numerous functional elements of the vehicle can be fitted directly thereto, away from the main assembly line. Such elements are subsequently fitted onto the body together with the support, in a single step, thereby saving on manufacturing costs.

Advantageously, the support includes referencing means for referencing a bumper skin of the vehicle with at least one element carried by the support.

By way of example, such an element may be the fender, the headlamp block, or indeed a central grille.

Thus, these referencing means enable the edges of the bumper skin to be positioned as close as possible to the various elements carried by the support so as to guarantee good control over the gaps and the flush portions between the bumper skin and each of those elements.

Optionally, the referencing means comprise a presser.

Advantageously, the support includes energy absorber means for placing in the vicinity of the top side rail of the motor vehicle.

When the support is put into place on the body in white of the vehicle, said means are to be found in the zone in which the head of a pedestrian will strike the vehicle in the event of an impact against a pedestrian. They serve to damp the impact suffered by the head of the pedestrian and thus guarantee better safety for people in the vicinity of the vehicle.

In a particular embodiment of the invention, the support includes fusible means for fastening the headlamp block to the support.

The headlamp block is a rigid element of the vehicle lying flush with the bodywork of the vehicle, and it is therefore likely to injure a pedestrian struck by the vehicle.

However, in this embodiment, in the event of an impact, the fastening of the headlamp block to the support breaks and the headlamp block slides towards the rear of the motor vehicle. The headlamp block is then no longer on the path followed by a pedestrian following an impact, and therefore no longer runs the risk of injuring the pedestrian. Pedestrian safety is thus further improved.

Optionally, the support is made at least in part out of a plastics material, in particular out of polypropylene (PP).

Advantageously, the support includes a portion made of a metal.

It is simpler to fasten together two elements that are made of the same material.

Thus, the support is hybrid: the metal portions thereof are designed to come into contact with the body in white, while the plastics material portions thereof are designed to come into contact with bodywork parts made of plastics material.

Such a support serves to guarantee simple fastening firstly of the support to the metal body in white of the vehicle, and secondly of bodywork elements made of plastics material, in particular the fender, on the support.

In a particular embodiment, the metal portion of the support is S-shaped, a first end of the S-shape being for securing to the bottom side rail of the motor vehicle, the opposite end thereof being for securing to the top side rail.

Optionally, the bonding outer surface and the portion of the inside face of the fender are secured to each other by adhesive or by heat sealing.

In a preferred embodiment of the invention, the fender is a motor vehicle front fender, with the proximal edge constituting the front edge of the fender.

The invention also provides a motor vehicle headlamp block support, characterized in that it forms part of the assembly of the invention.

In order to make the invention better understood, there follows a description of an embodiment given with reference to the accompanying drawing that is a perspective view of a headlamp block support in an embodiment of the invention.

### DESCRIPTION OF AN EXAMPLE

Vocabulary

| | | Reference in |
|---|---|---|
| In the claims | In the example | the drawing |
| Headlamp block | Support | 10 |
| support | | |
| Motor vehicle | Front fender | 12 |
| fender | | |
| Fender inside face | Inside face | 13 |
| Proximal edge of | Front edge of fender | 14 |
| fender | | |
| Bottom side rail | Bottom side rail | 15 |
| Top side rail | Top side rail | 16 |
| Outer bonding | Outer bonding surface | 18 |
| surface | | |
| Box | Box | 19 |
| Housing | Housing | 20 |
| | Support plate | 21 |
| | Bottom side rail | 22 |
| | fastener tab | |
| | Top side rail fastener | 22′ |
| | blade | |
| Energy absorber | Pedestrian impact | 24 |
| means | absorber | |
| Referencing means | Fender/bumper presser | 26, 26′ |
| Central grille | Fastener orifice | 28 |
| fastener means | | |
| | Box back wall | 30 |
| | Inner side wall of box | 32 |
| | Top wall of box | 34 |
| | Openings in the box | 36 |

In the figure, there can be seen the support 10 and the fender 12 put into place together on the body of a motor vehicle. The support 10 is compact: it extends between the front of the motor vehicle and the front of the vehicle wheel arch. It is secured to the bottom side rail 15 of the vehicle and to the top side rail 16, which side rails constitute the body of the motor vehicle in the vicinity of the headlamp block.

The tab 22 of the support 10 is secured to the outside face (facing towards the outside of the vehicle) of the bottom side rail in conventional manner, e.g. by screw fastening or by riveting, and for this purpose it includes a fastener orifice. The support is fastened to the bottom side rail at a single point, thus minimizing the number of fastening points between the support and the body so as to obtain better control firstly over the behavior of the support, and secondly over the transmission of forces to the body in the event of an impact. The blade 22′ of the support 10 is secured to the top face of the top side rail by screw fastening or by riveting.

The support 10 includes a metal box 19 defining a housing 20 for receiving a headlamp block, and means for fastening the headlamp block in the housing 20 (not shown in the figure). The box 19 is constituted by a bottom wall, forming a headlamp block support plate 21, an inner side wall 32, a back wall 30, and a curved top wall 34, closing the top of the box 19 and also closing its outer side.

The outside surface of the top wall 34 of the box 19 supports an outer bonding surface 18 for bonding with a portion of the inside face 13 of the fender 12, situated in the vicinity of the front edge 14 of the fender. Once the fender 12 has been bonded to the support 10, the bonding surface 18 extends along the front edge 14 of the fender 12. This bonding surface is made of plastics material and is secured to the box 19 by being overmolded thereon (achieving mechanical connection).

The support and the fender 12 are bonded together with the help of area type fastening, e.g. by adhesive or by heat sealing. In this way, any expansion of the front edge 14 of the fender 12 is prevented, and the gaps and flush portions between the support and the fender 12, and thus between the headlamp block and the fender are more accurate. Expansion of the front edge of the fender 12 is then transferred into the middle portion thereof which is not fastened and which bulges.

The side wall 32 and the back wall 30 of the box 19 include openings 36: these openings make it easy for an operator to change the bulb of the headlamp block without removing the block or the support.

The support 10 is hybrid: it includes the bonding surface 18 of plastics material, e.g. of polypropylene (PP) for assembling with the fender, which is likewise made of plastics material, while the remainder of the box is made of a metal, e.g. sheet metal, and is designed to be assembled with the vehicle body.

The metal portion of the support 10 is S-shaped, and it includes at its bottom end the tab 22, with the blade 22′ being arranged at its top end.

The metal portion also comprises the support plate 21 for the headlamp block, the side wall 22, and the back wall 30, forming parts of the box 19. Nevertheless the walls 30, 32 may include plastics material, molded around the peripheries of the openings 36, so as to avoid the operator being injured by sharp edges.

The element supporting the headlamp block is thus constituted by a material that is rigid.

The support also includes a pedestrian impact absorber 24 for putting into place on top of the top side rail 16 of the motor vehicle. This absorber 24, made in the metal portion of the support, extends towards the rear of the vehicle so as to cover a large portion of the top side rail 16. It comprises ribs for resting on the top side rail and for damping the impact suffered by the head of a pedestrian struck by the motor vehicle.

The support also includes fender/bumper pressers 26, 26′ of plastics material, in particular, in this embodiment, the support 10 includes a side presser 26 arranged on the top wall 34 in the vicinity of the bonding surface 18, and front presser 26′. These pressers 26, 26′ are obtained by overmolding plastics material onto the sheet metal of the support.

The pressers 26, 26′ are for mutually referencing the edges of the fender 12 and of the bumper of the motor vehicle. These pressers 26, 26′ comprise respective slideways with resilient tongues arranged to fit together the edges of the fender 12 and of the bumper.

The support 10 also has a fastener orifice 28 for positioning and fastening a central grille (not shown) of the vehicle by screw fastening. The support also has means for fastening a radiator (not shown) situated at the rear of the support, at the end of the support plate 21.

Thus, the support performs numerous functions and constitutes a genuine fender module capable of being fabricated away from the main assembly line. The fender is initially fitted onto the support prior to being fastened to the body of the motor vehicle.

Closing the box makes it possible to maintain the shape of the fender module in transport prior to being fastened to the vehicle, in particular by avoiding any deformation under the weight of the headlamp block in the event of the fender module being handled by being suspended via the blade 22′.

Variants

The means for fastening the headlamp block in the housing are fusible so as to prevent the headlamp block from injuring a pedestrian struck by the vehicle.

The support includes means for fastening other elements such as electric cables, an air guide, etc.

The outer wall 34 or the support 10 as a whole may be made of plastics material.

1. An assembly comprising a headlamp block support and a motor vehicle fender, the fender having an inside face, an outside face, and a proximal edge for being placed adjacent to a glass of the headlamp block, the support being designed to be secured to a bottom side rail and to a top side rail of the vehicle, wherein the support has a bonding outer surface for bonding to a portion of the inside face of the fender situated in the vicinity of the proximal edge of the fender, said bonding outer surface extending along the proximal edge of the fender.

2. The assembly according to claim 1, in which the support includes a box that defines a housing for receiving the headlamp block, an outer surface of the box including the bonding outer surface.

3. The assembly according to claim 1, in which the support includes fastener means for fastening at least one of the elements in the following list:
cooling means;
a central grille;
an air guide; and
an electric cable.

4. The assembly according claim 1, in which the support includes referencing means for referencing a bumper skin of the vehicle with at least one element carried by the support, and in particular the fender and the headlamp block.

5. The assembly according to claim 4, in which the referencing means comprise a presser.

6. The assembly according to claim 1, in which the support includes energy absorber means for placing in the vicinity of the top side rail of the motor vehicle.

7. The assembly according to claim 1, in which the support includes fusible means for fastening the headlamp block to the support.

8. The assembly according to claim 1, in which the support is made at least in part out of a plastics material, in particular out of polypropylene (PP).

9. The assembly according to claim 8, in which the support includes a portion made of a metal.

10. The assembly according to claim 9, in which the metal portion of the support is S-shaped, a first end of the S-shape being for securing to the bottom side rail of the motor vehicle, the opposite end thereof being for securing to the top side rail.

11. The assembly according to claim 1, in which the bonding outer surface and the portion of the inside face of the fender are secured to each other by adhesive or by heat sealing.

12. The assembly according to claim 1, in which the fender is a motor vehicle front fender, with the proximal edge constituting the front edge of the fender.

13. A support for a motor vehicle headlamp block, forming part of the assembly according to claim 1.
